(19) United States
(12) Patent Application Publication
(10) Pub. No.: US 2012/0213452 A1
(43) Pub. Date: Aug. 23, 2012

(54) IMAGE PROCESSING APPARATUS, IMAGE PROCESSING METHOD, COMPUTER PROGRAM AND IMAGING APPARATUS

(75) Inventors: Yoshiyuki Matsuyama, Fukuoka (JP); Kenji Tabei, Fukuoka (JP)

(73) Assignee: PANASONIC CORPORATION, Osaka (JP)

(21) Appl. No.: 13/372,711

(22) Filed: Feb. 14, 2012

(30) Foreign Application Priority Data
Feb. 17, 2011 (JP) 2011-032191
Feb. 1, 2012 (JP) 2012-019400

(51) Int. Cl. G06K 9/32

(52) U.S. Cl. 382/294; 382/296

(57) ABSTRACT

An image processing apparatus 100 selects one of multiple low-resolution images as a reference image candidate and determines transformation matrices for aligning the other aligning low-resolution images; conducts coordinate-transforming the other low-resolution images with the transformation matrices and plotting the reference image candidate and the coordinate-transformed low-resolution images on to a mapping image to generate a reconfigured image for reference image selection; gives a higher evaluation value to the reference image candidate as the number of pixels of the reference image candidate and the other low-resolution images plotted on the mapping image is larger. This image processing apparatus can select a reference image appropriate for generating a high-quality, high-resolution image from among multiple low-resolution images.

### BACKGROUND OF THE INVENTION

1. Field of the Invention

The present invention relates to an image processing apparatus, image processing method and computer program for performing super-resolution processing in which a high-resolution image is generated from multiple low-resolution images, and an imaging apparatus using them.

2. Description of the Related Art

Image processing apparatuses have been known in which a high-resolution image is generated by performing super-resolution processing using multiple low-resolution images. In such kind of image processing apparatus, one of the multiple low-resolution images is used as a reference image to perform coordinate-transformation of the other low-resolution images for alignment, and the coordinate-transformed low-resolution images are plotted on one mapping image to generate a reconfigured image. Then, pixels which are not plotted in the reconfigured image are interpolated to generate a high-resolution image.

In a conventional image processing apparatuses, for example, the first low-resolution image among the multiple low-resolution images is set as the reference image. In another conventional image processing apparatus, a low-resolution image with a small amount of blur is selected as the reference image.

Japanese Patent Laid-Open No. JP 2009-194896 A discloses such another conventional image processing apparatus.

In the super-resolution processing using multiple low-resolution images, the image quality of a generated high-resolution image can be improved by appropriately selecting a reference image. Therefore, when a reference image is selected not on the basis of the contents of an image, as in the example in which the first low-resolution image is set as a reference image, the reference image is not necessarily optimal for obtaining a high-quality, high-resolution image. Even if a reference image is selected on the basis of the amount of blur as in Japanese Patent Laid-Open No. 2009-194896, the reference image is also not necessarily optimal because the selection does not consider relations with the other low-resolution images.

The present invention has been made in view of the above problem, and an object thereof is to improve the image quality of the high-resolution image. Further, an object of the present invention is to provide an image processing apparatus capable of selecting a reference image appropriate for generating a high-quality, high-resolution image from among multiple low-resolution images.

### SUMMARY OF THE INVENTION

In order to solve the conventional problems, an image processing apparatus of the present invention has a configuration including: a low-resolution image acquiring unit which acquires plurality of low-resolution images;

a reference image selecting unit which selects a reference image from the plurality of low-resolution images; a first transformation matrix generating unit which generates a first transformation matrix for aligning low-resolution images other than the reference image with the reference image; a second transformation matrix generating unit which generates a second transformation matrix for predetermined coordinate-transforming the reference image and the low-resolution images other than the reference image; and a high-resolution image generating unit which coordinate-transforms the reference image with the second transformation matrix, coordinate-transforms the low-resolution images other than the reference image with the first and the second transformation matrix, plots the coordinate-transformed reference image and the coordinate-transformed low-resolution images other than the reference image onto a mapping image, and generates a high-resolution image.

According to this configuration, the second transformation matrix for coordinate-transforming the images is used along with the first transformation matrix for the alignment, during the generation of the high-resolution image by super-resolution processing. Accordingly, it is possible to generate the coordinate-transformed high-resolution image during the generation of the high-resolution image from the multiple low-resolution images by the super-resolution processing. In this way, since other coordinate-transformation processing is performed together with the super-resolution processing, it is possible to obtain quickly a high-quality, high-resolution image, in comparison to the other coordinate-transformation processing being separately performed after the super-resolution processing.

Moreover, in the image processing apparatus of the present invention, the second transformation matrix generating unit generates a second transformation matrix for performing rotation by a rotation angle set based on user input.

According to this configuration, the rotation angle for the second transformation matrix is set based on the user input. For example, a user can input a desired rotation angle to generate a high-resolution image rotated by the rotation angle.

Moreover, in the image processing apparatus of the present invention, if an inclination of a user-selected image specified from the plurality of low-resolution images by a user is different from an inclination of the reference image candidate, the second transformation matrix generating unit generates a second transformation matrix for performing rotation by a rotation angle for causing the inclination of the reference image candidate to correspond to the inclination of the user-selected image.

According to this configuration, if the inclination of the user-selected image (the image selected by the user) is different from the inclination (the rotation angle) of the reference image (for example, an image of a first frame) in the multiple low-resolution images, it is possible to generate a high-resolution image rotated so as to correspond to the inclination of the user-selected image.

Moreover, in the image processing apparatus of the present invention, the second transformation matrix generating unit generates a second transformation matrix for geometrically-deforming to the plurality of low-resolution images.

According to this configuration, it is possible to generate a high-resolution image that has been performed geometrically-deformation (for example, trapezoidal correction), during the generation of the high-resolution image from the multiple low-resolution images by the super-resolution processing.

Moreover, an image processing apparatus of the present invention is provided with: a low-resolution image acquiring unit acquiring multiple low-resolution images; an alignment unit selecting one of the multiple low-resolution images acquired by the low-resolution image acquiring unit as a reference image candidate and determining transformation matrices for aligning low-resolution images other than the reference image candidate with the reference-image-candidate low-resolution image; a reconfiguration processing unit coordinate-transforming the low-resolution images other than the reference image candidate with the transformation matrices and plotting the reference image candidate and the coordinate-transformed low-resolution images other than the reference image candidate onto a mapping image to generate a reconfigured image for reference image selection; an evaluation value calculating unit giving an evaluation value to the reference image candidate, the unit giving a higher evaluation value as the number of pixels of the reference image candidate and the coordinate-transformed low-resolution images other than the reference image candidate is larger and giving a higher evaluation value as the number of pixels of coordinate-transformed low-resolution images other than the reference image candidate which have been overlappedly plotted on the same pixels on the mapping image is smaller, in the reconfigured image for reference image selection; and a reference image selecting unit selecting, in the case of generating multiple reconfigured images for reference image selection by changing the low-resolution image to be selected as the reference image candidate among the multiple low-resolution images, the reference image candidate the evaluation value of which is high, among the multiple selected reference image candidates, as a reference image.

According to this configuration, such a reference image candidate is selected as a reference image that the number of pixels of the reference image candidate and the other low-resolution images plotted on a mapping image is large, and the number of pixels of low-resolution images which are overlappedly plotted on the same pixels on the mapping image is small. By using the reference image selected in this way, the number of pixels plotted on the mapping image is large and, therefore, the filling rate of mapping pixels on a mapping image is high.

Furthermore, the number of pixels overlappedly plotted on the same pixels on the mapping image is small and, therefore, the overlap rate of mapping pixels on the mapping image is low. Therefore, it is possible to preferably select a reference image which makes it possible to obtain a high-quality high-resolution image.

In the above image processing apparatus, the evaluation value calculating unit further may give, as an error in alignment between the reference-image-candidate low-resolution image and the low-resolution images other than the reference image candidate is smaller, a higher evaluation value to the reference image candidate.

According to this configuration, since such a low-resolution image that an error relative to the other low-resolution images is selected as a reference image, a reference image which makes it possible to obtain a high-quality, high-resolution image is more preferably selected.

In the above image processing apparatus, the alignment unit may determine the transformation matrix for an evaluation area which is a part of each of the multiple low-resolution images; and the reconfiguration processing unit may generate the reconfigured image for reference image selection for the evaluation area.

According to this configuration, evaluation for selecting a reference image is performed not using the whole image but using only an evaluation area which is a partial area. Therefore, the processing load can be reduced, and selection of a reference image can be speeded up. This configuration is effective especially when the number of low-resolution images is large.

In the above image processing apparatus, the alignment unit may select only a representative image among the multiple low-resolution images as the reference image candidate.

According to this configuration, when there are multiple low-resolution images for generating a high-resolution image, only a part of the low-resolution images (representative images) are set as reference image candidates. Therefore, it is not necessary to evaluate all the low-resolution images, and it is possible to reduce the processing load for reference image selection and speed up the reference image selection. This configuration is also effective when the number of low-resolution images is large.

In the above image processing apparatus, the alignment unit may perform matching among the multiple low-resolution images and, if there are multiple low-resolution images resembling one another, select one of the low-resolution images as the representative image.

As for low-resolution images resembling one another, it is considered that, no matter which of them is selected as a selected image, influence on the image quality of a high-resolution image does not differ much. Therefore, according to this configuration, as for low-resolution images resembling one another, by performing evaluation for reference image selection with only one of the low-resolution images as a reference image candidate, it is possible to reduce the processing load for reference image selection and speed up the reference image selection, and it is still possible to preferably select a reference image for obtaining a high-quality, high-resolution image.

In the above image processing apparatus, the alignment unit may select the representative images at equal intervals from the multiple low-resolution images arranged successively.

According to this configuration, it is possible to select a representative image by simple processing.

In the above image processing apparatus, the alignment unit may further determine transformation matrices for coordinate-transforming the low-resolution images other than the reference image for performing alignment with the reference image selected by the reference image selecting unit from among the multiple low-resolution images acquired by the low-resolution image acquiring unit; the reconfiguration processing unit may further coordinate-transforms the low-resolution images other than the reference image with the transformation matrices and plotting the reference image and the coordinate-transformed low-resolution images other than the reference image onto the mapping image to generate a reconfigured image; and the image processing apparatus may be further provided with a high-resolution image generating unit generating a high-resolution image by performing interpolation for the reconfigured image.

According to this configuration, it is possible to obtain a high-quality, high-resolution image using a preferably selected reference image.

The above image processing apparatus may further be provided with: a super-resolution processing area specifying unit specifying a super-resolution processing area where the high-resolution image is to be generated, in any of the multiple low-resolution images; and a rotation correcting unit performing rotation correcting an area corresponding to the super-resolution processing area in the high-resolution image generated by the high-resolution image generating unit so that the direction of the area corresponds to the direction of the super-resolution processing area.

According to this configuration, it is possible to, for a specified area, obtain a high-resolution image without inclination relative to the area.

Another aspect of the present invention is an imaging apparatus, and this imaging apparatus has a configuration including: any of the above image processing apparatuses, and an imaging unit generating the multiple low-resolution images by photographing a subject multiple times and providing the low-resolution images for the low-resolution image acquiring unit.

According to this configuration, it is possible to, immediately after photographing low-resolution images by the imaging apparatus, select a preferable reference image or obtain a high-quality, high-resolution image by the imaging apparatus.

Still another aspect of the present invention is an image processing method for coordinate- transforming a high-resolution image generated from a plurality of low-resolution images, the method comprising: generating a transformation matrix for rotation of the plurality of low-resolution images; and coordinate-transforming the plurality of the low-resolution images with the transformation matrix, plotting the coordinate-transformed low-resolution images onto mapping image, and generating a rotated high-resolution image.

Also according to this method, the second transformation matrix for rotating the images is used along with the first transformation matrix for the alignment, during the generation of the reconfigured image for the super-resolution processing. Accordingly, it is possible to generate the rotated high-resolution image during the generation of the high-resolution image from the multiple low-resolution images by the super-resolution processing. In this way, since the rotation processing is performed before the super-resolution processing, it is possible to obtain quickly a high-quality, high-resolution image in comparison to the rotation processing being separately performed after the super-resolution processing.

Still another aspect of the present invention is a computer program for causing a computer to implement the above image processing method.

The present invention can provide an image processing apparatus having an effect of enabling geometrically-deforming processing (such as rotation processing) and super-resolution processing at the same time, and achieving a high-quality, high-resolution image.

### BRIEF DESCRIPTION OF THE DRAWINGS

FIG. 1 is a block diagram showing the configuration of an image processing apparatus in a first embodiment of the present invention;

FIG. 2(A) shows that a reference image candidate is enlarged with a super-resolution magnification rate and discretely arranged on a mapping image in the first embodiment of the present invention, and FIG. 2(B) shows that all low-resolution images other than the reference image candidate are coordinate-transformed, enlarged and plotted on the mapping image in the first embodiment of the present invention;

FIG. 3 is a diagram illustrating mapping of the pixels of the multiple low-resolution images onto the mapping image in the first embodiment of the present invention;

FIG. 4 is a flowchart showing an operation of the image processing apparatus performed for determining the reference image in the first embodiment of the present invention;

FIG. 5 is a flowchart of an operation of the image processing apparatus performed for generating a high-resolution image after the reference image is determined, in the first embodiment of the present invention;

FIG. 6(A) is a diagram illustrating a case where a mean value SA of pixel-value mean errors A is relatively small in a variation of the first embodiment of the present invention, and FIG. 6(B) is a diagram illustrating a case where a mean value SA of the pixel-value mean errors A is relatively large in the variation of the first embodiment of the present invention;

FIG. 7 is a block diagram showing the configuration of an image processing apparatus in a second embodiment of the present invention;

FIG. 8 is a diagram showing an example of an evaluation area in the second embodiment of the present invention;

FIG. 9 is a block diagram showing the configuration of an image processing apparatus in a third embodiment of the present invention;

FIG. 10 is a block diagram showing the configuration of an image processing apparatus in a fourth embodiment of the present invention;

FIG. 11 is a diagram illustrating super-resolution processing of an image processing apparatus in the fourth embodiment of the present invention;

FIG. 12 is a diagram illustrating rotation correction processing by a high-resolution image rotation correcting unit in the fourth embodiment of the present invention;

FIG. 13 is a block diagram showing the configuration of an image processing apparatus in a fifth embodiment of the present invention;

FIG. 14 is a diagram illustrating a rotation correction transformation matrix B=R·A in the fifth embodiment of the present invention;

FIG. 15 is a diagram showing another example of a rotation correction matrix R in the fifth embodiment of the present invention;

FIG. 16 is a diagram illustrating reconfiguration processing in the fifth embodiment of the present invention;

FIG. 17 is a flowchart illustrating a flow of an operation of the image processing apparatus in the fifth embodiment of the present invention;

FIG. 18 is a diagram showing an example of image processing in the fifth embodiment of the present invention;

FIG. 19 is a diagram showing another example of the image processing in the fifth embodiment of the present invention; and

FIG. 20 is a block diagram showing the configuration of an imaging apparatus of a sixth embodiment of the present invention.

### DETAILED DESCRIPTION OF THE PREFERRED EMBODIMENTS

Embodiments for practicing the present invention will be described below with reference to drawings.

### First Embodiment

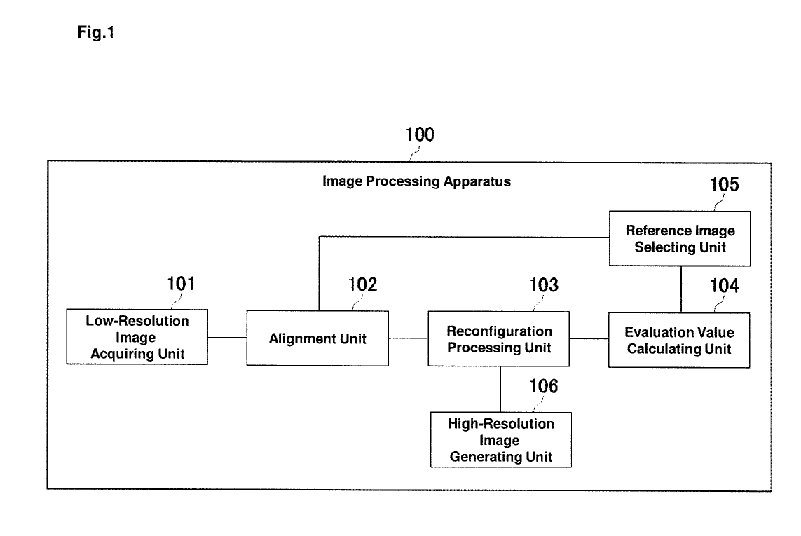

FIG. 1 is a block diagram showing the configuration of an image processing apparatus 100 in a first embodiment of the present invention. The image processing apparatus 100 is provided with a low-resolution image acquiring unit 101, an alignment unit 102, a reconfiguration processing unit 103, an evaluation value calculating unit 104, a reference image selecting unit 105 and a high-resolution image generating unit 106.

The low-resolution image acquiring unit 101 acquires multiple low-resolution images which have been obtained by performing photographing multiple times. The low-resolution image acquiring unit 101 may acquire multiple low-resolution images by an external camera, may acquire multiple low-resolution images by receiving the multiple low-resolution images transmitted via a communication network, or may acquire multiple low-resolution images by reading the multiple low-resolution images recorded in a recording medium.

The alignment unit 102 (1st transformation matrix generating unit) selects one of the multiple low-resolution images acquired by the low-resolution image acquiring unit 101 as a reference image candidate and determines a transformation matrix (1st transformation matrix) for performing coordinate-transformation of each of the other low-resolution images relative to the reference image candidate so that the low-resolution image is aligned relative to the reference image candidate. Specifically, the alignment unit 102 performs feature-point matching between the reference image candidate and each of the other low-resolution images, detects four corresponding points between the reference image candidate and the low-resolution image, and calculate a projective transformation matrix.

This projective transformation matrix is a transformation matrix showing the relationship between the reference image candidate and the low-resolution image. By performing coordinate-transformation of the low-resolution image using this projective transformation matrix, the low-resolution image is aligned with the reference image candidate. The alignment unit 102 (1st transformation matrix generating unit) determines the projective transformation matrix (1st transformation matrix) for each of all the low-resolution images other than the selected reference image candidate.

The reconfiguration processing unit 103 transforms, for all the low-resolution images, their coordinate system to the coordinate system of the reference image candidate using the transformation matrix (1st transformation matrix) calculated by the alignment unit 102 (1st transformation matrix generating unit). Then, the reconfiguration processing unit 103 enlarges the reference image candidate and the low-resolution images other than the reference image candidate, which have been coordinate-transformed, with a super-resolution magnification rate. The reconfiguration processing unit 103 plots the pixels of the enlarged reference image candidate and the pixels of the low-resolution images other than the reference image candidate, which have been coordinate-transformed and enlarged, on a mapping image.

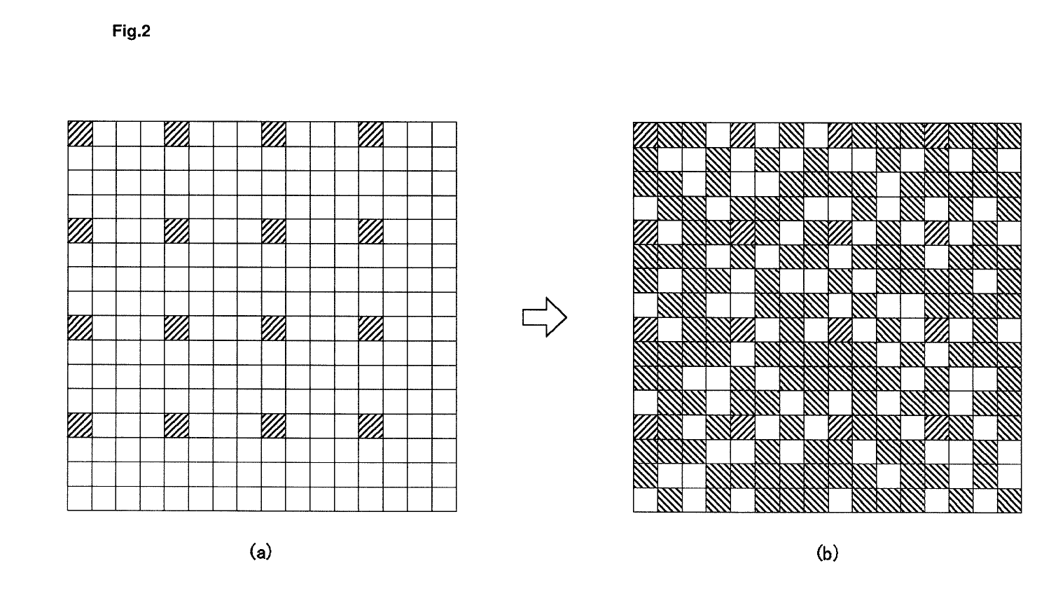

FIG. 2(A) is a diagram showing that the reference image candidate is enlarged with the super-resolution magnification rate and discretely arranged on the mapping image. In FIG. 2(A), the pixels of the reference image candidate plotted on the mapping image are shown with oblique lines toward the upper right. In this embodiment, for simplification of description, it is assumed that: the low-resolution image has a size of 4 pixels×4 pixels; the super-resolution magnification rate is 4 times vertically and horizontally; a mapping image has, therefore, a size of 16 pixels×16 pixels; and a pixel of the reference image is arranged every 4 pixels vertically and horizontally on the mapping image. Actually, the size of the low-resolution image may be larger.

The reconfiguration processing unit 103 plots (performs mapping of) the pixels of all the low-resolution images other than the reference image candidate, the coordinate system of which has been transformed to that of the reference image, onto this mapping image. The reconfigured image generated by performing mapping on the mapping image using the reference image candidate in order to select a reference image in this way corresponds to a reconfigured image for reference image selection of the present invention.

FIG. 2(B) is a diagram showing that all the low-resolution images other than the reference image candidate have been coordinate-transformed, enlarged and plotted on the mapping image. In FIG. 2(B), the pixels of the low-resolution images other than the reference image candidate are shown with oblique lines toward the lower right.

In general, even if the pixels of all the low-resolution images are plotted on the mapping image, the pixels of the low-resolution images are not plotted on all the pixels of the mapping image, as shown in FIG. 2(B). In the mapping image, there exist some pixels on which pixels of the low-resolution images are not plotted. Furthermore, among pixels on which pixels of the low-resolution images have been plotted, in the mapping image, there are also included pixels on which pixels of multiple low-resolution images are overlappedly plotted.

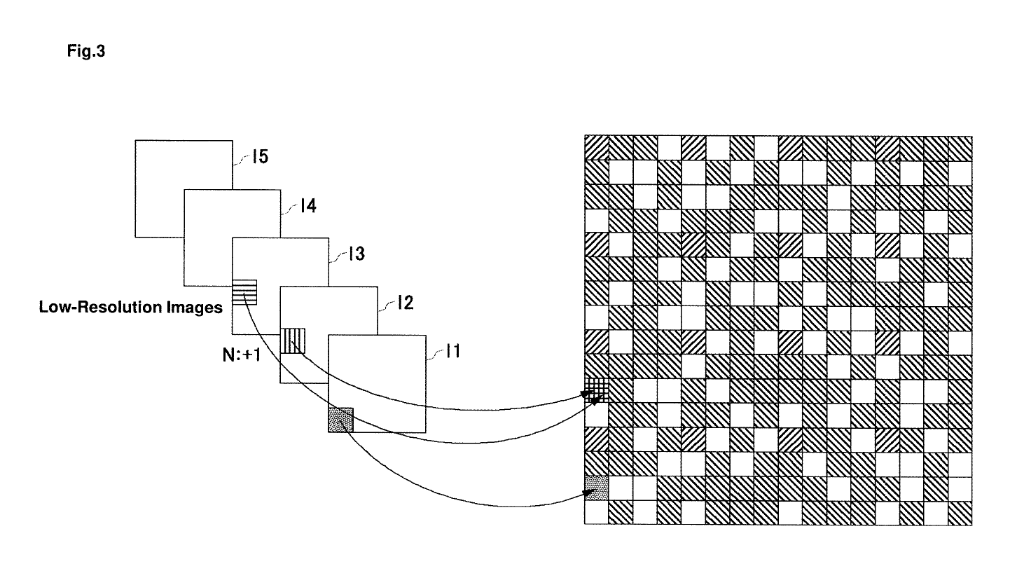

FIG. 3 is a diagram illustrating mapping of the pixels of the multiple low-resolution images onto the mapping image. As shown in FIG. 3, when there is a string of low-resolution images 11 to 15, for example, the pixel at the lower left corner of the low-resolution image 11 is plotted onto the mapping image (the pixel at the second line from the bottom and the first column from the left) by coordinate-transformation and enlargement. In the example of FIG. 3, the pixels on the first column from the left and on the second line from the bottom in the low-resolution images 12 and 13 are coordinate-transformed, enlarged, and plotted onto the same pixel in the mapping image when being plotted onto the mapping image.

The evaluation value calculating unit 104 determines a total number P of the pixels of the reference image candidate and the pixels of the low-resolution images other than the reference image candidate which have been plotted onto the mapping image (hereinafter, these will be collectively referred to as “effective pixels”). That is, this total number P of the effective pixels is the total number of the pixels attached with oblique lines toward the upper right and the pixels attached with oblique lines toward the lower right in the mapping image in FIG. 2(B).

The evaluation value calculating unit 104 also calculates the number of pixels of low-resolution images which have been overlappedly plotted on the same pixels of the mapping image as described above (that is, the total number of pixels of low-resolution images which have been plotted again on pixels of the mapping image on which pixels of the reference image candidate or the other low-resolution images have been already plotted) N. Then, an evaluation value E for the reference image candidate is calculated from an equation (1) below with the use of the total number of pixels M of the mapping image (in the example of FIG. 2, 16 pixels×16 pixels).

E=(P−N)/M (1)

For each of multiple low-resolution images acquired by the low-resolution image acquiring unit 101, the alignment unit 102, the reconfiguration processing unit 103 and the evaluation value calculating unit 104 performs the above process with the low-resolution image as a reference image candidate, and calculates an evaluation value.

When, for each of all the multiple low-resolution images, an evaluation value has been calculated with the low-resolution image as a reference image candidate, the reference image selecting unit 105 selects a reference image candidate given the highest evaluation value as a reference image.

When the reference image selecting unit 105 selects the reference image, the alignment unit 102 determines a transformation matrix for each of the other low-resolution images using the selected reference image. The alignment unit 102 may use the transformation matrices calculated in the process of selecting the reference image then. The reconfiguration processing unit 103 performs mapping of the pixels of the reference image and the pixels of the other low-resolution images onto the mapping image. The reconfigured image generated by performing mapping on the mapping image using the reference image selected by the reference image selecting unit in this way corresponds to a reconfigured image of the present invention.

In this case, when pixels of multiple low-resolution images are overlappedly plotted on the same pixel on the mapping image, the first pixel is adopted. As a variation, when plotting is overlappedly performed, the reconfiguration processing unit 103 may adopt a pixel which is temporally the closest to the reference image among the plotted pixels or may adopt a pixel which is the closest to the mean value of the multiple pixels overlappedly plotted.

The high-resolution image generating unit 106 performs super-resolution processing using the reconfigured image and generates a high-resolution image. Specifically, the high-resolution image generating unit 106 performs filling of pixels in the mapping image on which plotting has not been performed with pixels by interpolation processing. The high-resolution image generating unit 106 further estimates the amount of blur of the image (PSF: Point Spread Function), performs restoration processing for the blur by inverse transformation and outputs the image as a high-resolution image.

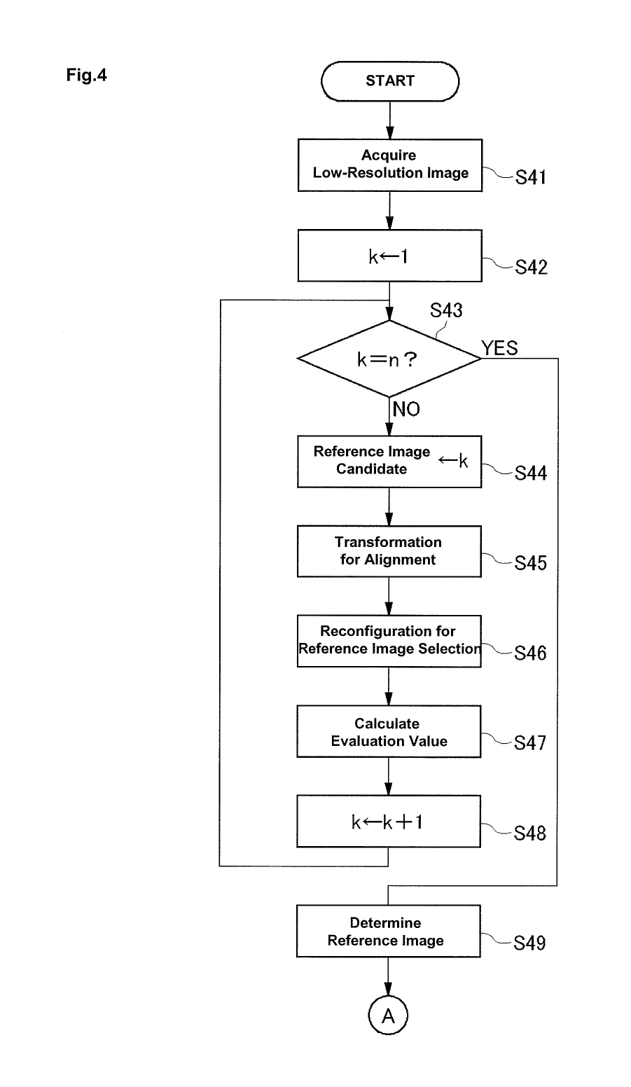

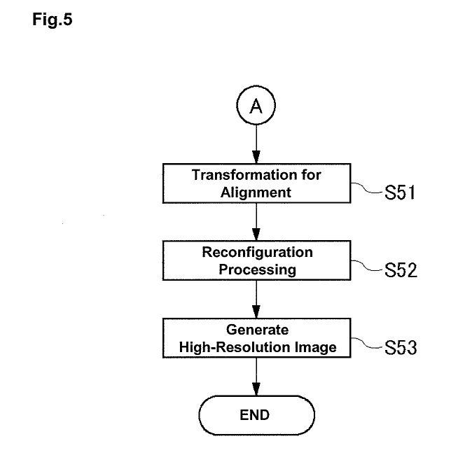

An image processing method in the image processing apparatus configured as described above will be described. FIG. 4 is a flowchart showing an operation of the image processing apparatus performed for determining a reference image, and FIG. 5 is a flowchart showing an operation of generation of high-resolution image after the reference image is determined. First, the process of determining a reference image will be described with reference to FIG. 4.

The low-resolution image acquiring unit 101 acquires multiple (n) low-resolution images (step S41). Next, a number k of a low-resolution image selected as a reference image candidate is set to 1 (step S42). That is, the first low-resolution image is selected as a reference image candidate. Next, it is determined whether k=n is satisfied (step S43). That is, it is determined whether or not, for each of all the low-resolution images, an evaluation value has been calculated with the low-resolution image as a reference image candidate.

If calculation of an evaluation value for each of all the low-resolution images has not ended with the low-resolution image as a reference image candidate (step S43: NO), the alignment unit 102 selects the k-th low-resolution image as a reference image candidate (step S44). Then, the alignment unit 102 determines a projective transformation matrix for each of the other low-resolution images for alignment relative to the reference image candidate (step S45). Next, the reconfiguration processing unit 103 arranges the pixels of the reference image candidate on a mapping image, and the pixels of each low-resolution image transformed with a transformation matrix and enlarged onto the mapping image to generate a reconfigured image for reference image selection (step S46).

The evaluation value calculating unit 104 calculates an evaluation value E in the reconfiguration processing for reference image selection (step S47). After that, k is incremented (step S48), and the flow returns to step S43. Steps S44 to S48 are repeated until k=n is satisfied, that is, until, for each of all the n low-resolution images, the process of calculating an evaluation value with the low-resolution image as a reference image candidate ends. When, for each of all the n low-resolution images, the process of calculating an evaluation value with the low-resolution image as a reference image candidate ends (step S43: YES), the reference image selecting unit 105 determines a reference image candidate given the highest evaluation value among the calculated evaluation values as a reference image (step S49).

Next, super-resolution processing using a reference image performed after selection of the reference image, that is, a process of generating a high-resolution image will be described with reference to FIG. 5. Using the selected reference image, the alignment unit 102 determines a transformation matrix for each of the other low-resolution images relative to the reference image (step S51). As described above, the alignment unit 102 may use the transformation matrices calculated in the process of selecting the reference image then. The reconfiguration processing unit 103 generates a reconfigured image by coordinate-transforming the other low-resolution images using the transformation matrices and mapping the pixels of the reference image and the pixels of the other low-resolution images which have been coordinate-transformed onto a mapping image (step S52). Next, the high-resolution image generating unit 106 generates a high-resolution image using the reconfigured image (step S53).

As described above, according to the image processing apparatus of the first embodiment, such a reference image candidate is selected as a reference image that the number of pixels of the reference image candidate and the other low-resolution images plotted on a mapping image is large, and the number of pixels of low-resolution images which are overlappedly plotted on the same pixels on the mapping image is small. By generating a high-resolution image using a reference image selected in this way, the number of pixels plotted on the mapping image is large and, therefore, the filling rate of mapping pixels on a mapping image is high. Furthermore, the number of pixels overlappedly plotted on the same pixels on the mapping image is small and, therefore, the overlap rate of mapping pixels on the mapping image is low. As a result, a high-quality, high-resolution image can be obtained.

In the above first embodiment, the filling rate of mapping pixels in a mapping image and the overlap rate of mapping pixels in the mapping image are reflected on an evaluation value. The evaluation value of the present invention, however, is not limited thereto. A variation will be described below.

Variation

As described above, the alignment unit 102 determines a transformation matrix for transforming the coordinate system of a low-resolution image to the coordinate system of a reference image candidate by performing feature-point matching. There may be a case, however, where the accuracy of this matching is not high. In the case where the accuracy of matching by the alignment unit 102 is low, an error between a reference image and the other low-resolution images remains even after coordinate-transformation using transformation matrices. Consequently, an appropriate reconfigured image cannot be generated, and an unclear high-resolution image with a low image quality is generated. Therefore, in the variation of the first embodiment, the magnitude of the error between a reference image candidate and the other low-resolution images is further reflected on evaluation values used for selecting a reference image.

The evaluation value calculating unit 104 of an image processing apparatus of the variation of the first embodiment reflects a mean error of pixel values between a reference image candidate and the other low-resolution images on an evaluation value, in addition to the filling rate and overlap rate of mapping pixels in a mapping image. Specifically, when a pixel-value mean error between a low-resolution image (referred to a “corrected image”) other than a reference image candidate and the reference image candidate is denoted by A, the evaluation value calculating unit 104 determines a mean value SA among the pixel-value mean errors A of all the corrected images.

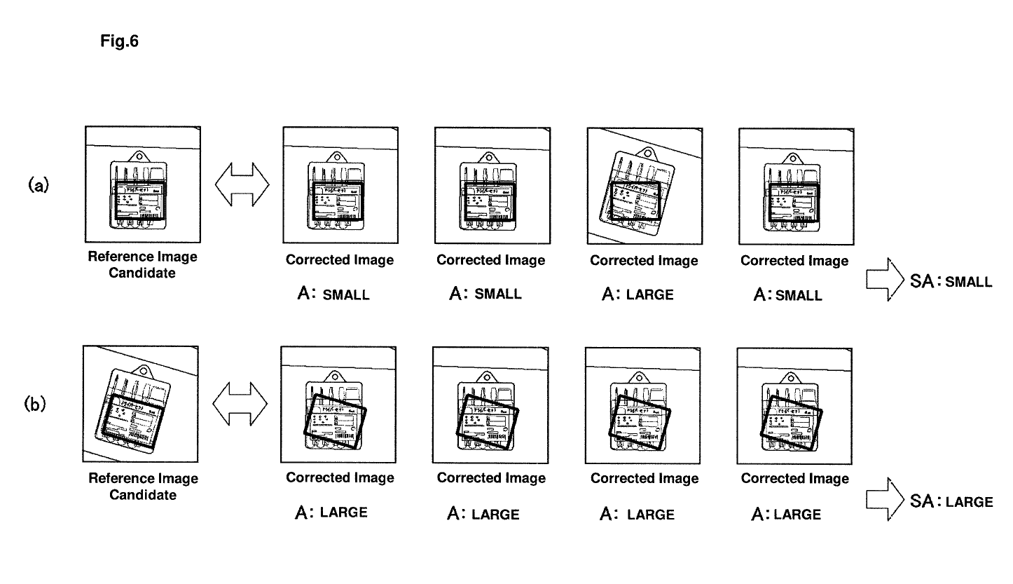

FIG. 6 is a diagram showing an example of the error. FIG. 6(A) shows a case where the error of corrected images relative to a reference image candidate is small, and FIG. 6(B) shows a case where the error of corrected images relative to a reference image candidate is large. That is, in the example in FIG. 6(A), the pixel-value mean errors A of corrected images 1, 2 and 4 are relatively small, and the pixel-value mean error A of a corrected image 3 is relatively large. As a result, in the case of FIG. 6(A), the mean value SA of the pixel-value mean errors A of all the corrected images is relatively small.

In comparison, in the case of FIG. 6(B), the pixel-value mean errors A of all corrected images 1 to 4 are relatively large, and, as a result, the mean value SA of the pixel-value mean errors A of all the corrected images is relatively large.

The evaluation value calculating unit 104 calculates an evaluation value E from an equation (2) below using the mean value SA of the pixel-value mean errors A of all corrected images.

E={(P−N)/M}−kSA (2)

Here, a coefficient k is a parameter for pixel-value mean error adjustment indicating the degree (weight) of reflecting matching accuracy on an evaluation value. Apparent from the equation (2), the evaluation value decreases as the mean value SA of pixel-value mean errors A increases.

According to this variation, since such a low-resolution image that an error relative to the other low-resolution images is selected as a reference image, it is possible to more preferably select a reference image which makes it possible to obtain a high-quality, high-resolution image.

### Second Embodiment

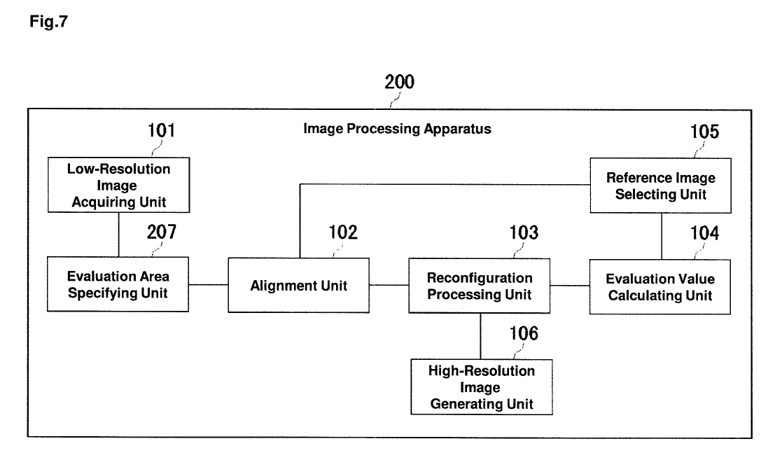

FIG. 7 is a block diagram showing the configuration of an image processing apparatus 200 of a second embodiment of the present invention. In the image processing apparatus 200 in FIG. 7, components similar to those of the image processing apparatus 100 of the first embodiment are given the same reference numerals, and description thereof will be omitted. The image processing apparatus 200 of this embodiment is further provided with an evaluation area specifying unit 207, in addition to the components of the image processing apparatus 100 of the first embodiment.

The evaluation area specifying unit 207 specifies a partial area in a low-resolution image acquired by the low-resolution image acquiring unit 101 as an evaluation area. As for calculation of a transformation matrix by the alignment unit 102, generation of a reconfigured image for reference image selection by the reconfiguration processing unit 103 and calculation of an evaluation value by the evaluation value calculating unit 104, all of them are performed in this evaluation area. After a reference image is selected by reference image selection using such an evaluation area, super-resolution processing of all the low-resolution images as a whole to generate a high-resolution image.

The evaluation area specifying unit 207 of this embodiment specifies a partial area with the central point of a low-resolution image as the center, as the evaluation area. As a variation, the evaluation area specifying unit 207 may specify an area where feature points are congested in feature-point matching as the evaluation area or may specify an area specified by a user as the evaluation area. The shape of the evaluation area may be a rectangle, a circle or any other arbitrary shape.

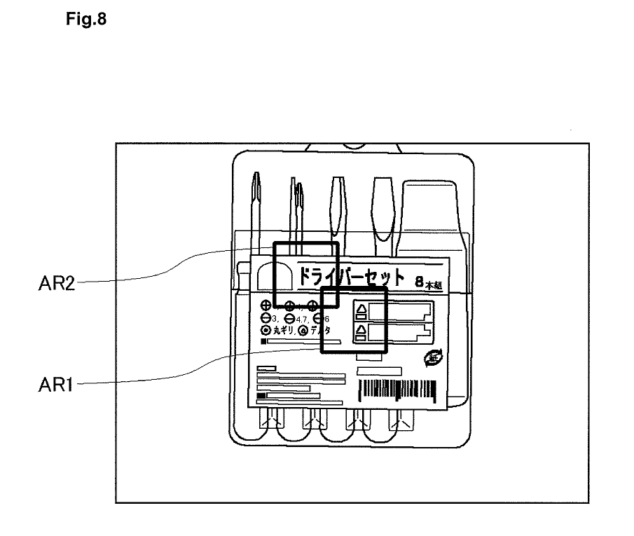

FIG. 8 is a diagram showing an example of the evaluation area. An area AR1 in the figure is a rectangular area with the central point of a low-resolution image as the center, which has been specified as an evaluation area by the evaluation area specifying unit 207 of this embodiment. An area AR2 is an evaluation area specified as an area where feature points are congested in feature-point matching, by the evaluation area specifying unit 207 of the variation.

According to the image processing apparatus 200 of the second embodiment, evaluation for selecting a reference image is performed not using the whole low-resolution image but using only an evaluation area which is a partial area. Therefore, the processing load can be reduced, and selection of a reference image can be speeded up. This embodiment is effective especially when the number of low-resolution images acquired by the low-resolution image acquiring unit 101 is large.

### Third Embodiment

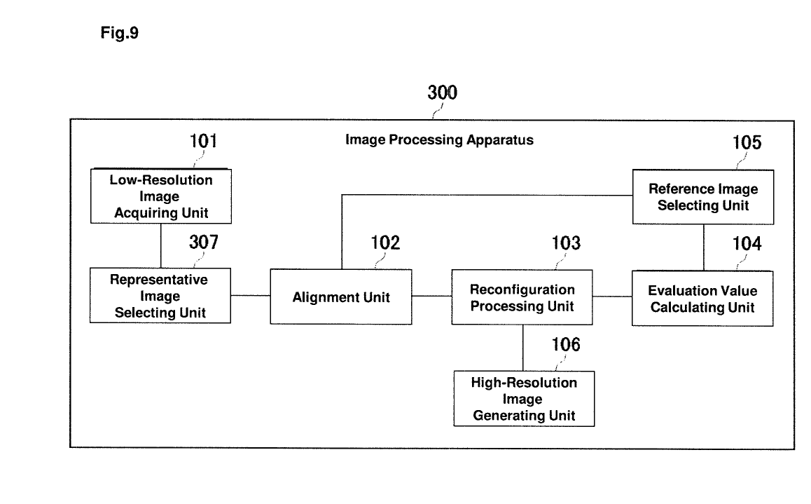

FIG. 9 is a block diagram showing the configuration of an image processing apparatus 300 of a third embodiment of the present invention. In the image processing apparatus 300 in FIG. 9, components similar to those of the image processing apparatus 100 of the first embodiment are given the same reference numerals, and description thereof will be omitted. The image processing apparatus 300 of this embodiment is further provided with a representative image selecting unit 307, in addition to the components of the image processing apparatus 100 of the first embodiment.

The representative image selecting unit 307 selects only representative images among multiple low-resolution images acquired by the low-resolution image acquiring unit 101, as reference image candidates. Specifically, the representative image selecting unit 307 performs matching of all the multiple low-resolution images acquired by the low-resolution image acquiring unit 101. If there are multiple low-resolution images resembling one another, one of them is selected as the representative image. As for a low-resolution image for which there is no other low-resolution image resembling the low-resolution image, the representative image selecting unit 307 selects such a low-resolution image also as a representative image.

That is, specifically, the representative image selecting unit 307 performs matching among multiple low-resolution images, and, if there are such multiple low-resolution images that the matching scores among them are higher than a predetermined threshold, determines that the low-resolution images resemble one another. The representative image selecting unit 307 selects one of the multiple low-resolution images resembling one another, as a representative image. The other low-resolution images are not selected as a reference image candidate, and evaluation values using the low-resolution images as reference image candidates are not calculated.

The reason for the representative image selecting unit 307 selecting a representative image in this way is as follows. That is, as for such multiple low-resolution images that the matching scores among them are high, evaluation values calculated are close to one another. Therefore, it is considered that, no matter which of them is selected as a selected image, influence on the image quality of a high-resolution image does not differ much. Therefore, for multiple low-resolution images with high matching scores, only one of them can be selected as a reference image candidate, and it can be determined whether or not to set it as a reference image.

By omitting calculation of an evaluation value for a part of multiple acquired low-resolution images without calculating the evaluation value for all of them, it is possible to reduce the processing load for reference image selection and speed up the reference image selection.

From a point of view that, by omitting calculation of an evaluation value for a part of low-resolution images, it is possible to reduce the processing load for reference image selection and speed up the reference image selection, it is possible to select only a part of low-resolution images as reference image candidates by performing culling from the multiple low-resolution images in an arbitrary method or extracting some of the multiple low-resolution images in an arbitrary method, calculate evaluation values for them, and select a reference image from among the reference image candidates. In this case, though there is a possibility that an image optimal as a reference image, among the multiple low-resolution images acquired by the low-resolution image acquiring unit 101, is excluded from selection, an optimum image among the multiple selected low-resolution images can be selected as a reference image. That is, in comparison with a case where the reference image selection using an evaluation value according to this embodiment is not performed, a more desirable reference image can be selected.

Therefore, the representative image selecting unit 307 of a variation of this embodiment selects, for example, only multiple low-resolution images extracted at equal intervals from multiple low-resolution images arranged successively, as reference image candidates. The reference image candidate selected in this way corresponds to a representative image of the present invention.

This embodiment may be implemented simultaneously with the second embodiment. That is, according to this embodiment, by selecting, from among multiple low-resolution images acquired, a part of the low-resolution images as reference image candidates (representative images) and calculating evaluation values for only a partial area (evaluation area) of each of the reference image candidates, a reference image may be selected from among the selected reference image candidates.

### Fourth Embodiment

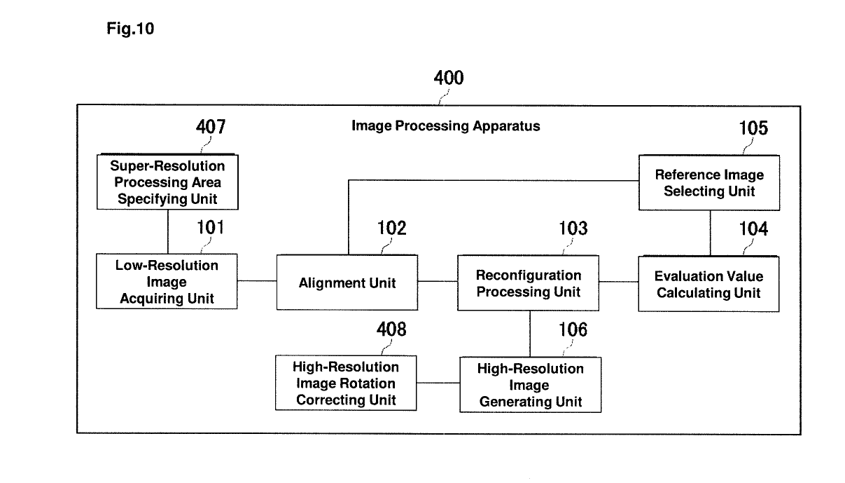

FIG. 10 is a block diagram showing the configuration of an image processing apparatus 400 of a fourth embodiment of the present invention. In the image processing apparatus 400 in FIG. 10, components similar to those of the image processing apparatus 100 of the first embodiment are given the same reference numerals, and description thereof will be omitted. The image processing apparatus 400 of this embodiment is further provided with a super-resolution processing area specifying unit 407 and a high-resolution image rotation correcting unit 408, in addition to the components of the image processing apparatus 100 of the first embodiment.

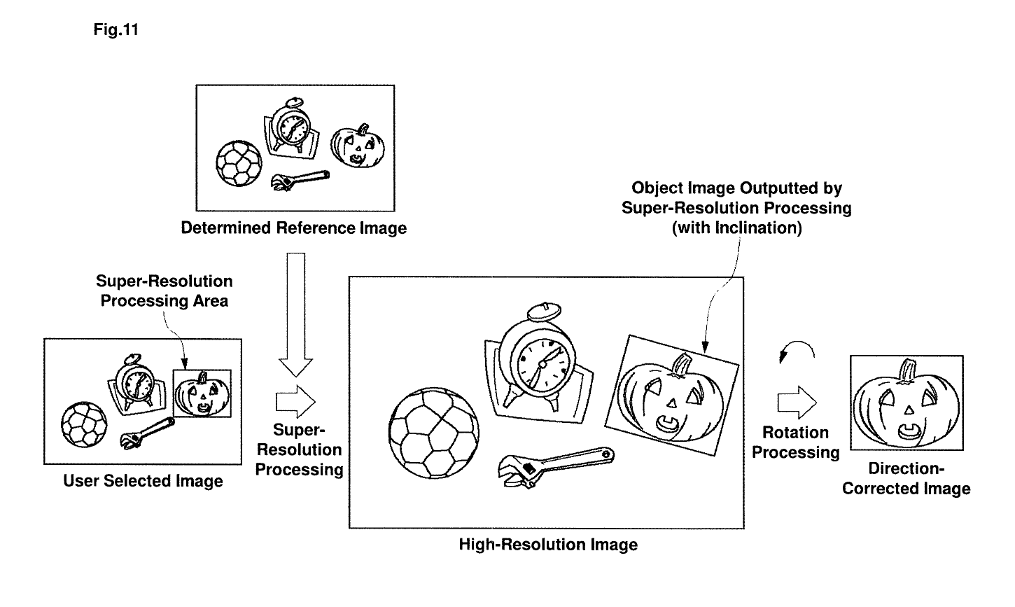

FIG. 11 is a diagram illustrating super-resolution processing in the image processing apparatus 400 of the fourth embodiment. The super-resolution processing area specifying unit 407 specifies an area where super-resolution processing, that is, a high-resolution image generation process is to be performed, in accordance with an instruction by the user. The user selects an arbitrary low-resolution image from among multiple low-resolution images acquired by the low-resolution image acquiring unit 101. This image is a user-selected image in FIG. 11.

As shown in FIG. 11, the user specifies an area where super-resolution processing is to be performed, in this user-selected image. In this case, the super-resolution processing area is selected as a rectangular area. On the other hand, the image processing apparatus 400 selects a reference image, and performs super-resolution processing using the selected reference image to generate a high-resolution image, similar to the first embodiment. An image corresponding to the super-resolution processing area selected by the user, in the high-resolution image generated in this way is not necessarily in the same direction as the super-resolution processing area selected in the user-selected image by the user. There may be a case where the image leans.

Therefore, the high-resolution image rotation correcting unit 408 performs rotation correction of the super-resolution processing area in the generated high-resolution image so that the inclination of the super-resolution processing area corresponds to the inclination of the super-resolution processing area specified by the user in the user-selected image. An image obtained in this way is the direction-corrected image in FIG. 11.

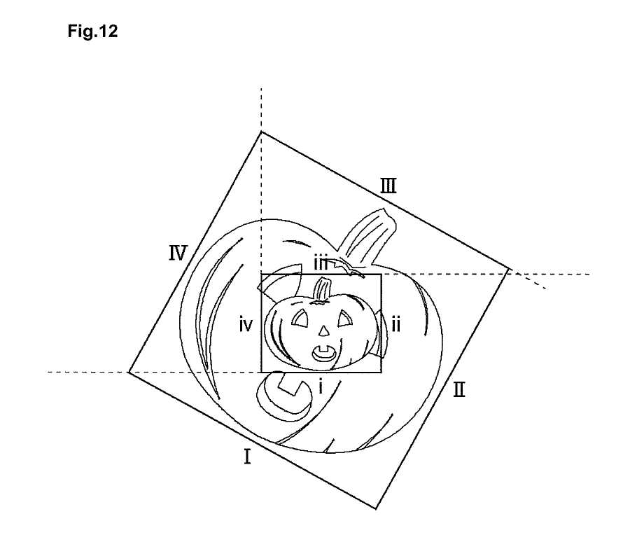

FIG. 12 is a diagram illustrating the rotation correction processing by the high-resolution image rotation correcting unit 408. Regarding the mean of inclinations of the sides of a super-resolution processing area in the high-resolution image relative to the sides of the super-resolution processing area in the user-selected image as an inclination (rotation angle) of the super-resolution processing area in the high-resolution image relative to the super-resolution processing area in the user-selected image, the high-resolution image rotation correcting unit 408 reversely rotates the super-resolution processing area of the high-resolution image by this rotation angle.

That is, by determining each of the inclination of a side I of the super-resolution processing area of the high-resolution image relative to a side i of the super-resolution processing area of the user-selected image, the inclination of a side II of the super-resolution processing area of the high-resolution image relative to a side ii of the super-resolution processing area of the user-selected image, the inclination of a side III of the super-resolution processing area of the high-resolution image relative to a side iii of the super-resolution processing area of the user-selected image, and the inclination of a side IV of the super-resolution processing area of the high-resolution image relative to a side iv of the super-resolution processing area of the user-selected image, determining the mean of them, determining a rotation angle of the super-resolution processing area of the high-resolution image relative to the super-resolution processing area of the user-selected image, and reversely rotating the super-resolution processing area of the high-resolution image by this rotation angle, the high-resolution image rotation correcting unit 408 causes the direction of the super-resolution area of the high-resolution image to correspond to the direction of the super-resolution area of the user-selected image.

According to the image processing apparatus 400 of the fourth embodiment, it is possible to obtain a high-resolution image in which a specified area corresponds to a super-resolution processing area specified by the user and the directions of the areas are the same. In the image processing apparatus 400 of the fourth embodiment, the reference image selection method in the second embodiment, the reference image selection method in the third embodiment or both of them may be adopted to select a reference image. In the case of adopting the reference image selection method of the second embodiment, the super-resolution processing area specified by the user may be set as an evaluation area.

### Fifth Embodiment

Next, an image processing apparatus in a fifth embodiment of the present invention will be described. Differences between the image processing apparatus in the fifth embodiment and the fourth embodiment will be mainly described herein. Unless otherwise stated herein, the configuration and the operation of the present embodiment are similar to the fourth embodiment.

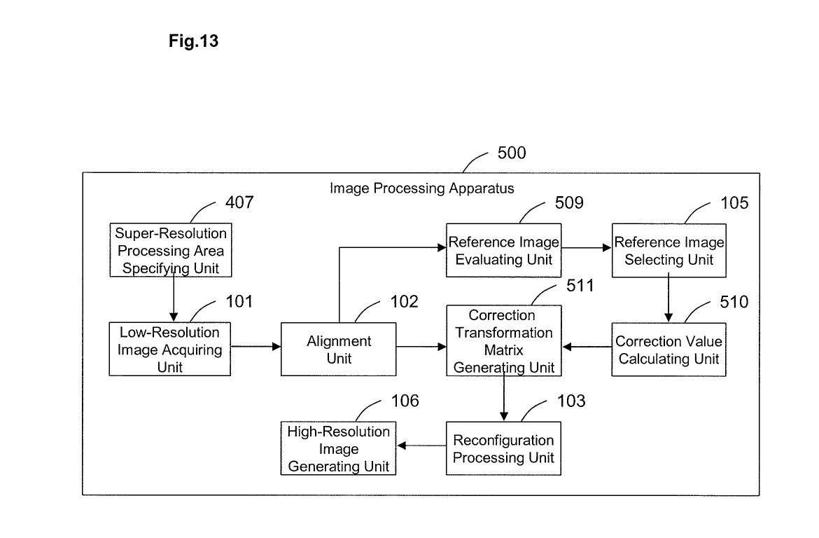

FIG. 13 is a block diagram showing the configuration of the image processing apparatus in the present embodiment. As shown in FIG. 13, the image processing apparatus in the present embodiment is provided with a reference image evaluating unit 509, a correction value calculating unit 510, and a correction transformation matrix generating unit 511.

The reference image evaluating unit 509 calculates an evaluation value for determining whether or not an input image selected as the reference image candidate (for example, the user-selected image) is appropriate for the reference image. The reference image evaluating unit 509 calculates the evaluation value by converting elements for the determination into scores. For example, the elements for the determination include (1) whether or not the reference image candidate is blurring, (2) whether or not the reference image candidate has an extremely small size, (3) whether or not an inclination of the reference image candidate is appropriate, (4) whether or not a filling rate of the reference image candidate (the filling rate of the mapping image) is low, (5) whether or not a result of matching between the reference image candidate and other input images is low, and the like. It should be noted that this evaluation value may be comprehensively calculated from the above five elements for the determination (1) to (5). Moreover, an approach similar to the above described approach of the evaluation value calculating unit 104 may be used to calculate the evaluation value.

The reference image selecting unit 105 selects an input image (reference image candidate) given the highest evaluation value by the reference image evaluating unit 509, as the reference image.

The correction value calculating unit 510 is, for instance, provided with a function of calculating a rotation angle θ to be used in the rotation correction processing. For example, similarly to the fourth embodiment, if the inclination of the user-selected image which is selected by the super-resolution processing area specifying unit 407 is different from an inclination of the reference image which is selected by the reference image selecting unit 105, the correction value calculating unit 510 calculates the inclination of the super-resolution processing area of the high-resolution image relative to the super-resolution processing area of the user-selected image, as the rotation angle θ. In this case, the rotation angle θ may be calculated from the inclination of a corresponding side (for example, the side I in the example of FIG. 12) of the super-resolution processing area of the high-resolution image relative to a side (for example, the side i in the example of FIG. 12) of the super-resolution processing area of the user-selected image. Moreover, the rotation angle θ may be specified by user input if the user wants to rotate the image by a desired rotation angle, or the like. Moreover, when the character string is contained in the image, the direction of the character string may be detected, and the angle along this direction or inclined at a predetermined angle may be selected as the rotation angle θ.

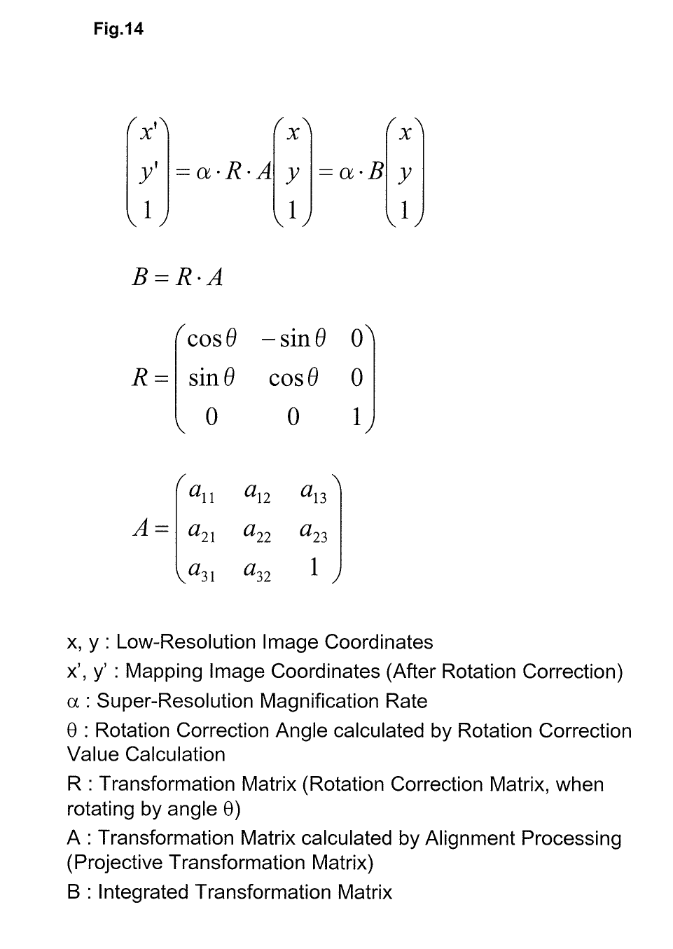

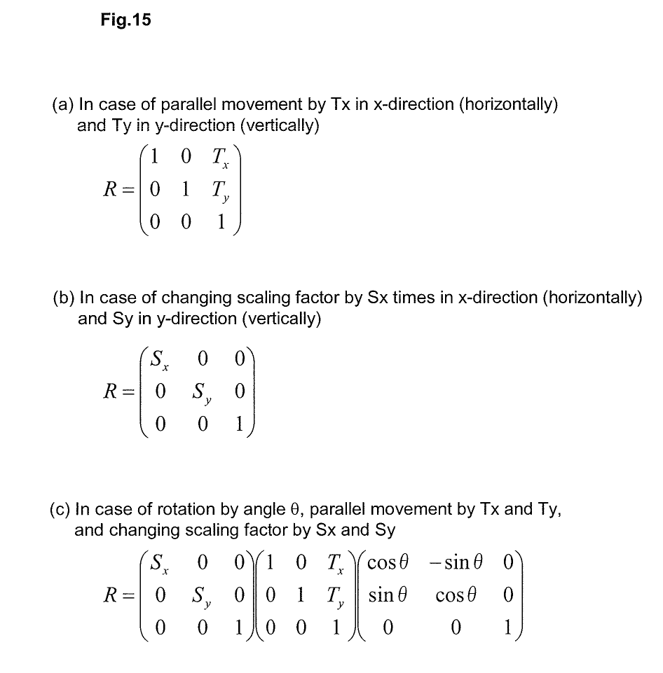

The correction transformation matrix generating unit 511 generates a transformation matrix R (2nd transformation matrix) for rotating the reference image which is selected by the reference image selecting unit 105 and the low-resolution images other than the reference image, for instance. As shown in FIG. 14, this transformation matrix R may be, for example, a rotation correction transformation matrix for performing rotation by the rotation angle θ. Moreover, as shown in FIG. 15(a), a transformation matrix R for performing only parallel movement horizontally by Tx and vertically by Ty may be used. Alternatively, as shown in FIG. 15(b), a transformation matrix R for only changing a scaling factor (scaling) horizontally by Sx times and vertically by Sy times may be used. Furthermore, as shown in FIG. 15(c), a transformation matrix R which is integrated with the transformation matrix for performing the rotation by the angle θ, the parallel movement by Tx and Ty, and the scaling by Sx and Sy may be used. In addition, according to the transformation matrix R, geometrically-deforming such as mirror reversing or deformation, so-called affine transformation can be performed.

Then, as shown in FIG. 14, the correction transformation matrix generating unit 511 finally calculates a integrated transformation matrix R (=R·A) based on the transformation matrix R as described above (for example, the rotation correction transformation matrix R for performing the rotation by the rotation angle θ) and a projective transformation matrix A (1st transformation matrix) for transforming low-resolution image other than the reference image to the reference image, the transformation matrix A being calculated by alignment unit 102 (1st transformation matrix generating unit).

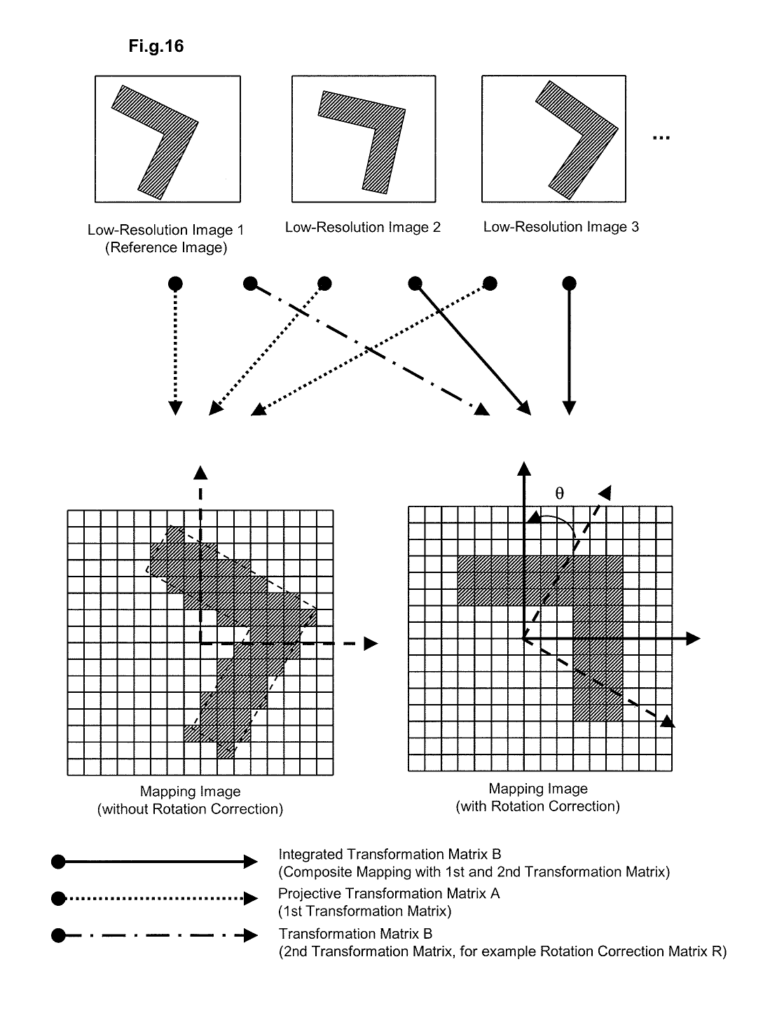

The reconfiguration processing unit 103 coordinate-transforms multiple input images (low-resolution images) with the transformation matrix α·B, where the integrated transformation matrix B calculated by the correction transformation matrix generating unit 511 is multiplied by the enlargement factor of the super-resolution α. That is, coordinate-transforms the low-resolution images other than the reference image with the transformation matrix A, and also coordinate-transforms the reference image and the low-resolution images other than the reference image with the transformation matrix R. In other words, the reference image is coordinate-transformed with the transformation matrix R (2nd transformation matrix) and the low-resolution images other than the reference image are coordinate-transformed with the projective transformation matrix A (1st transformation matrix) and the transformation matrix R. Alternatively, the reference image is coordinate-transformed with the transformation matrix R and the low-resolution images other than the reference image are coordinate-transformed with the integrated transformation matrix B. That is, as shown in FIG. 16, the transformation matrix R (rotation correction transformation matrix R) is used to the reference image (low-resolution image 1), the integrated transformation matrix B (in which the projective transformation matrix A and the rotation correction transformation matrix are combined) is used to the images other than the reference images (low-resolution images 2, 3, . . . ), and thus the input image is plotted to the mapping image (high-resolution space), by single coordinate-transformation processing, to generate the reconfigured image.

The high-resolution image generating unit 106 fills-in, by interpolation processing, the pixels which are not plotted in the mapping image thus-generated by the reconfiguration processing unit 103, to generate, for example, a rotated high-resolution image.

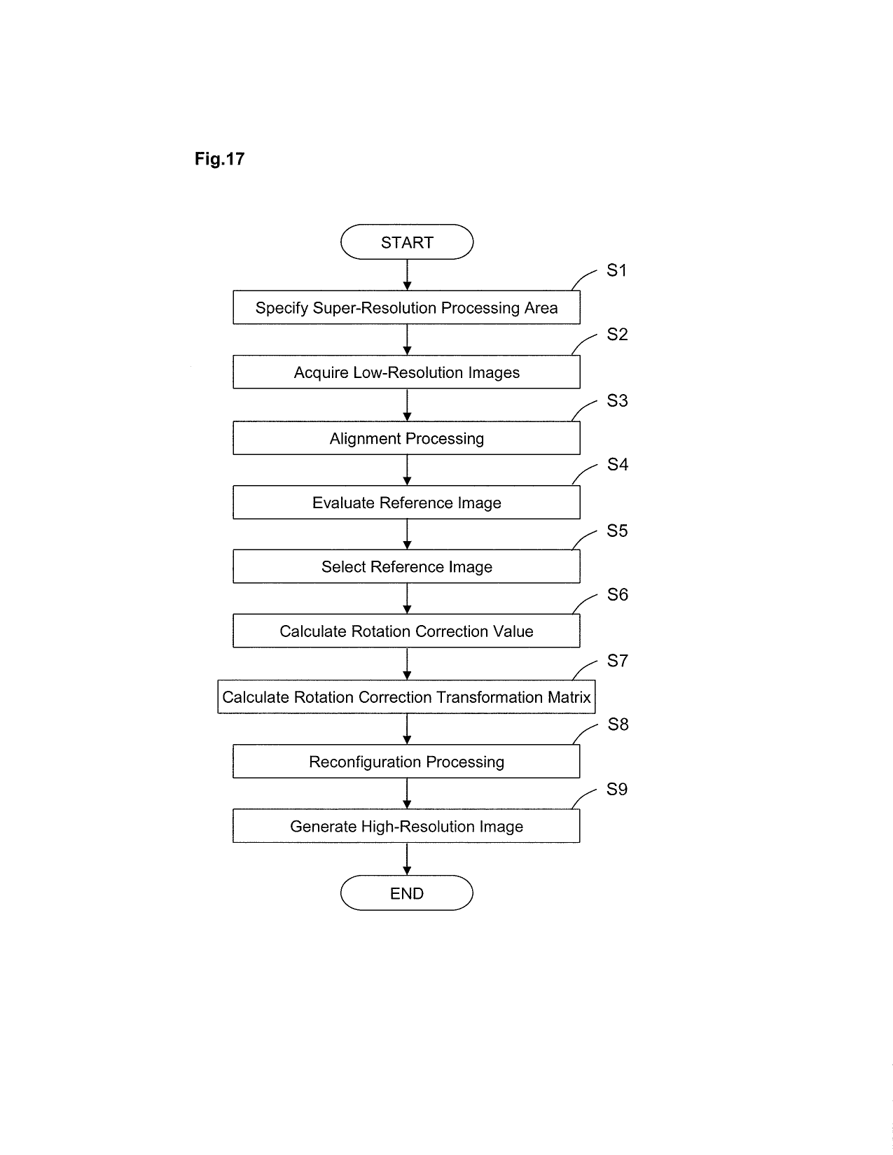

The operation of the image processing apparatus in the fifth embodiment configured as described above will be described with reference to a flowchart of FIG. 17.

To generate a high-resolution image from low-resolution images by using the image processing apparatus in the present embodiment, first, the user specifies the super-resolution processing area in one input image (low-resolution image) (S1). Then, the multiple input images (low-resolution images) to be used in the super-resolution processing are acquired (S2), and the alignment processing for the multiple low-resolution images and the reference image candidate is performed (S3). The projective transformation matrix A for the alignment is obtained then. Next, the reference image evaluation is performed based on the evaluation value calculated for each reference image candidate (S4), and the input image (reference image candidate) given the highest evaluation value is selected as the reference image (S5).

The processing by the transformation matrix R is not specified as described above, however, the explanation of the rotation correction processing will be continued as an example, for the sake of simplicity.

Next, the rotation angle θ to be used in the rotation correction processing is calculated (S6). For example, if the inclination of the user-selected image is different from the inclination of the reference image, the inclination of the super-resolution processing area of the high-resolution image relative to the super-resolution processing area of the user-selected image is calculated as the rotation angle θ. It should be noted that the rotation angle θ may be specified by the user input if the user wants to rotate the image by the desired rotation angle, or the like. Then, the integrated transformation matrix B (=R·A) is calculated based on the transformation matrix R for performing the rotation by the rotation angle θ (for example, the rotation correction transformation matrix R for performing the rotation by the rotation angle θ) and the transformation matrix A calculated by the alignment processing (the projective transformation matrix A for the alignment) (S7).

Subsequently, the multiple input images (low-resolution images) are coordinate-transformed with the integrated transformation matrix B, and the coordinate-transformed input images are plotted onto the mapping image (high-resolution space) to generate the reconfigured image (S8). Then, by using thus-generated reconfigured image, the pixels which are not plotted in the mapping image is filled-in by interpolation processing, to generate the high-resolution image (rotated high-resolution image) (S9).

According to the image processing apparatus in the fifth embodiment as described above, a second transformation matrix for rotating the images (the transformation matrix R) is used along with a first transformation matrix for the alignment (the projective transformation matrix A), during the generation of the reconfigured image for the super-resolution processing. Accordingly, it is possible to generate the rotated high-resolution image during the generation of the high-resolution image from the multiple low-resolution images by the super-resolution processing. In this way, since rotation processing is performed together with the super-resolution processing, it is possible to process in short time and to obtain a high-quality and high-resolution image without calculation-error accumulation, in comparison to the rotation processing being separately performed after the super-resolution processing.

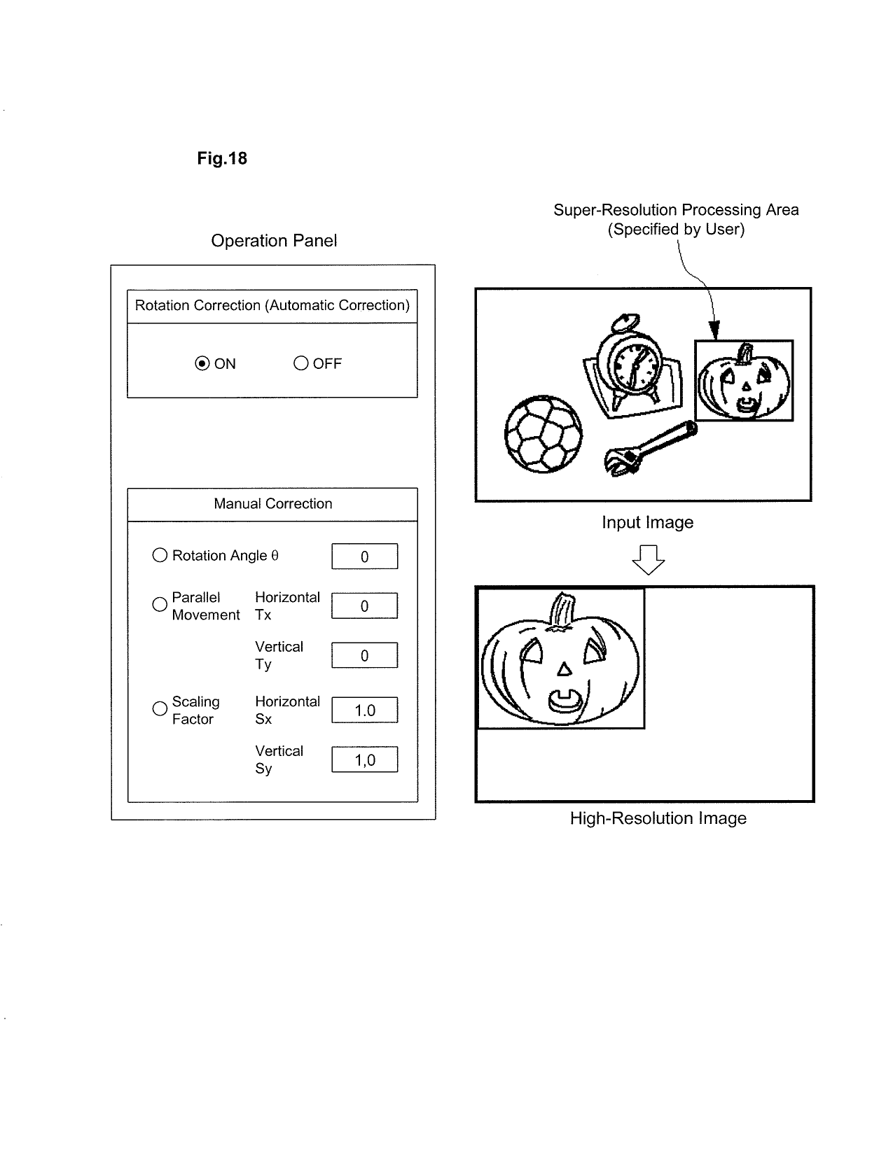

For example, similarly to the fourth embodiment, the inclination of the user-selected image may be different from the inclination of the reference image candidate in the multiple low-resolution images. In the present embodiment, in such a case, as shown in FIG. 18, it is possible to automatically generate a high-resolution image rotated (automatically corrected) so as to correspond to the inclination of the user-selected image.

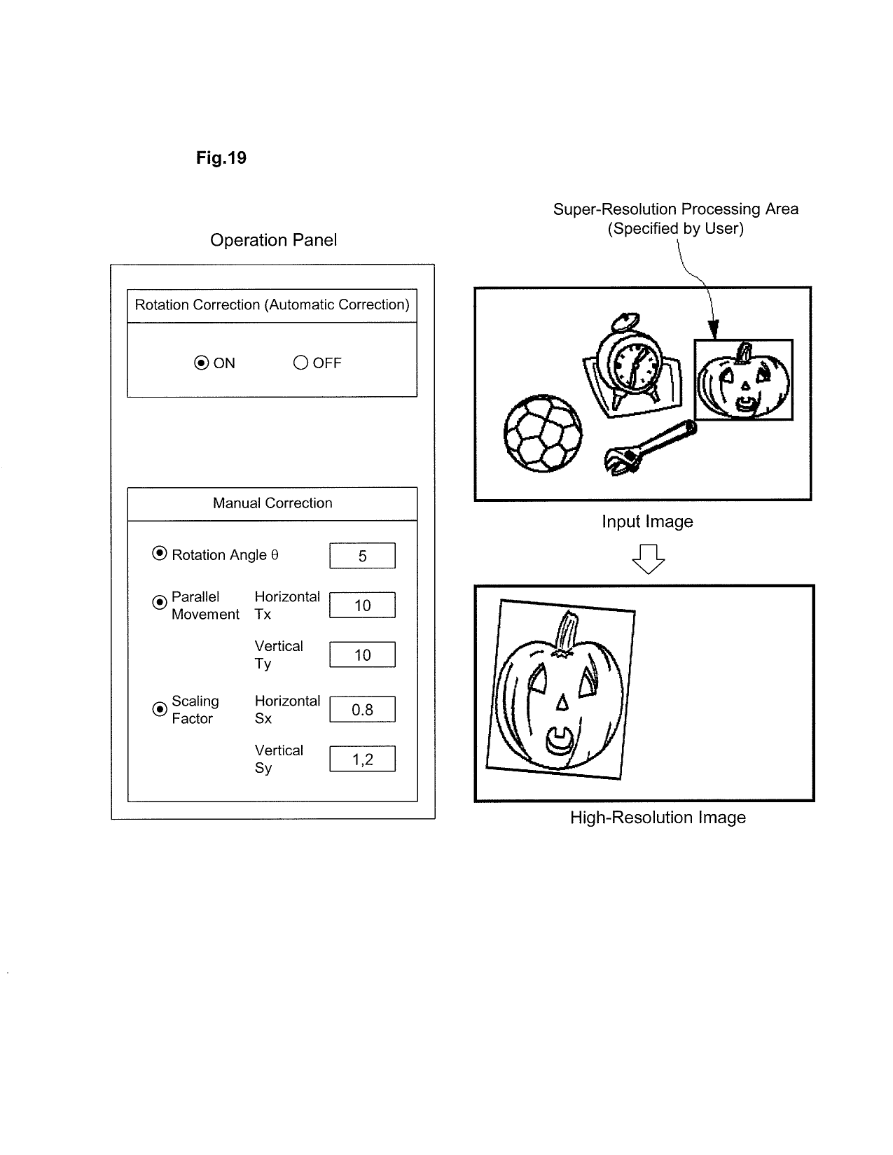

Moreover, in the present embodiment, the rotation angle for the second transformation matrix can be set based on the user input. For example, if the user wants to rotate the image by the desired rotation angle, as shown in FIG. 19, the user can input the rotation angle θ (for example, five degrees) to generate a high-resolution image rotated (manually corrected) by the rotation angle.

Moreover, in the present embodiment, it is possible to generate a high-resolution image (rotated and) moved in parallel, during the generation of the high-resolution image from the multiple low-resolution images by the super-resolution processing. For example, if the user wants to move the image in parallel by a desired amount of movement, as shown in FIG. 19, the user can input the amount of movement for the parallel movement (horizontally: Tx, vertically: Ty) to generate a high-resolution image moved in parallel (manually corrected) by the amount of movement.

Moreover, in the present embodiment, it is possible to generate a high-resolution image (rotated and moved in parallel and) changed in the scaling factor, during the generation of the high-resolution image from the multiple low-resolution images by the super-resolution processing. For example, if the user wants to scale the image by a desired scaling factor, as shown in FIG. 19, the user can input the scaling factor for the scaling (horizontally: Sx, vertically: Sy) to generate a high-resolution image scaled (manually corrected) by the scaling factor.

Moreover, in the present embodiment, it is possible to generate a high-resolution image which is geometrically-deformed to the original image, during the generation of the high-resolution image from the multiple low-resolution images by the super-resolution processing. For example, when the user desires conducting deformation based on specific coordinate-transformation or trapezoidal correction, it is possible to generate a high-resolution image in which rhombic deformation is conducted, by setting “1” in place of “cos θ” and setting “−0.5” in place of “sin θ, −sin θ” in the transformation matrix R in FIG. 14.

### Sixth Embodiment

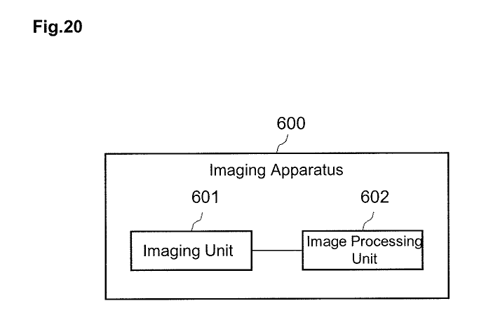

FIG. 20 is a block diagram showing the configuration of an imaging apparatus 600 of a sixth embodiment of the present invention. The imaging apparatus 600 is provided with an imaging unit 601 which generates a low-resolution image by photographing, and an image processing unit 602 which generates a high-resolution image using multiple low-resolution images generated by the imaging unit 601. As the image processing unit 602, any of the image processing apparatuses of the first to fifth embodiment can be adopted.

The imaging unit 601 generates multiple low-resolution images by photographing a subject multiple times and provides the low-resolution images for a low-resolution image acquiring unit of the image processing unit 602. According to the imaging apparatus 600 of this embodiment, it is possible to, immediately after photographing low-resolution images by the imaging unit 601, select a preferable reference image and obtain a high-quality, high-resolution image by the imaging apparatus 600.

As described above, the present invention is useful as an image processing apparatus or the like capable of selecting a reference image which makes it possible to obtain a high-quality high-resolution image and performing super-resolution processing for generating a high-resolution image from multiple low-resolution images.

What is claimed is:

1. An image processing apparatus comprising:
a low-resolution image acquiring unit which acquires plurality of low-resolution images;
a reference image selecting unit which selects a reference image from the plurality of low-resolution images;
a first transformation matrix generating unit which generates a first transformation matrix for aligning low-resolution images other than the reference image with the reference image;
a second transformation matrix generating unit which generates a second transformation matrix for predetermined coordinate-transforming the reference image and the low-resolution images other than the reference image; and
a high-resolution image generating unit which coordinate-transforms the reference image with the second transformation matrix, coordinate-transforms the low-resolution images other than the reference image with the first and the second transformation matrix, plots the coordinate-transformed reference image and the coordinate-transformed low-resolution images other than the reference image onto a mapping image, and generates a high-resolution image.

2. The image processing apparatus according to claim 1, wherein the second transformation matrix generating unit generates a second transformation matrix for performing rotation by a rotation angle set based on user input.

3. The image processing apparatus according to claim 1, wherein if an inclination of a user-selected image specified from the plurality of low-resolution images by a user is different from an inclination of the reference image candidate, the second transformation matrix generating unit generates a second transformation matrix for performing rotation by a rotation angle for causing the inclination of the reference image candidate to correspond to the inclination of the user-selected image.

4. The image processing apparatus according to claim 1, wherein the second transformation matrix generating unit generates a second transformation matrix for geometrically-deforming to the plurality of low-resolution images.

5. The image processing apparatus according to claim 1, further comprising a reference image evaluating unit which calculates a filling rate of the low-resolution image as a evaluation value for selecting the reference image from the plurality of the low-resolution images, wherein the reference image selecting unit selects the reference image based on the evaluation value.

6. An image processing apparatus comprising:
a low-resolution image acquiring unit acquiring plurality of low-resolution images;
an alignment unit selecting one of the plurality of low-resolution images acquired by the low-resolution image acquiring unit as a reference image candidate and determining transformation matrices for aligning low-resolution images other than the reference image candidate with the reference-image-candidate low-resolution image;
a reconfiguration processing unit coordinate-transforming the low-resolution images other than the reference image candidate with the transformation matrices and plotting the reference image candidate and the coordinate-transformed low-resolution images other than the reference image candidate onto a mapping image to generate a reconfigured image for reference image selection;
an evaluation value calculating unit giving an evaluation value to the reference image candidate, the unit giving a higher evaluation value as the number of pixels of the reference image candidate and the coordinate-transformed low-resolution images other than the reference image candidate is larger and giving a higher evaluation value as the number of pixels of coordinate-transformed low-resolution images other than the reference image candidate which have been overlappedly plotted on the same pixels on the mapping image is smaller, in the reconfigured image for reference image selection; and
a reference image selecting unit selecting, in the case of generating plurality of reconfigured images for reference image selection by changing the low-resolution image to be selected as the reference image candidate among the plurality of low-resolution images, the reference image candidate the evaluation value of which is high, among the plurality of selected reference image candidates, as a reference image.

7. The image processing apparatus according to claim 6, wherein the evaluation value calculating unit further gives, as an error in alignment between the reference-image-candidate low-resolution image and the low-resolution images other than the reference image candidate is smaller, a higher evaluation value to the reference image candidate.

8. The image processing apparatus according to claim 6, wherein
the alignment unit determines the transformation matrix for an evaluation area which is a part of each of the plurality of low-resolution images; and
the reconfiguration processing unit generates the reconfigured image for reference image selection for the evaluation area.

9. The image processing apparatus according to claim 6, wherein the alignment unit selects only a representative image among the plurality of low-resolution images as the reference image candidate.

10. The image processing apparatus according to claim 9, wherein the alignment unit performs matching among the plurality of low-resolution images and, if there are plurality of low-resolution images resembling one another, selects one of the low-resolution images as the representative image.

11. The image processing apparatus according to claim 9, wherein the alignment unit selects representative images at equal intervals from the plurality of low-resolution images arranged successively.

12. The image processing apparatus according to claim 6, wherein
the alignment unit further determines transformation matrices for coordinate-transforming the low-resolution images other than the reference image for performing alignment with the reference image selected by the reference image selecting unit from among the plurality of low-resolution images acquired by the low-resolution image acquiring unit;
the reconfiguration processing unit further coordinate-transforms the low-resolution images other than the reference image with the transformation matrices and plotting the reference image and the coordinate-transformed low-resolution images other than the reference image onto the mapping image to generate a reconfigured image; and
the image processing apparatus further comprises a high-resolution image generating unit generating a high-resolution image by performing interpolation for the reconfigured image.

13. The image processing apparatus according to claim 12, further comprising:
a super-resolution processing area specifying unit specifying a super-resolution processing area where the high-resolution image is to be generated, in any of the plurality of low-resolution images; and
a rotation correcting unit performing rotation correcting an area corresponding to the super-resolution processing area in the high-resolution image generated by the high-resolution image generating unit so that the direction of the area corresponds to the direction of the super-resolution processing area.

14. An imaging apparatus comprising:
the image processing apparatus according to claim 1; and
an imaging unit generating the plurality of low-resolution images by photographing a subject plurality of times and providing the low-resolution images for the low-resolution image acquiring unit.

15. An image processing method for coordinate-transforming a high-resolution image generated from a plurality of low-resolution images,
the method comprising:
generating a transformation matrix for rotation of the plurality of low-resolution images; and
coordinate-transforming the plurality of the low-resolution images with the transformation matrix, plotting the coordinate-transformed low-resolution images onto mapping image, and generating a rotated high-resolution image.

16. A computer program for causing a computer to implement the image processing method according to claim 15.
